(19) United States
(12) Patent Application Publication
(10) Pub. No.: US 2017/0091415 A1
(43) Pub. Date: Mar. 30, 2017

(54) MEDICATION ADHERENCE

(71) Applicant: Apple Inc., Cupertino, CA (US)

(72) Inventors: Serhan O. Isikman, Cupertino, CA (US); Andrzej T. Baranski, Cupertino, CA (US); Todd K. Whitehurst, Cupertino, CA (US)

(21) Appl. No.: 14/871,895

(22) Filed: Sep. 30, 2015

(51) Int. Cl. G06F 19/00; H04W 68/00; G06F 1/16

(52) U.S. Cl. CPC G06F 19/3456; G06F 1/163; H04W 68/00

(57) ABSTRACT

In some implementations, a computing device can receive a prescription for a user from a medication container device. The container device can be encoded with the prescription and can transmit the prescription (e.g., medication schedule and dosage information) to the computing device. The computing device can schedule presentation of reminders for the user to take the prescribed medication according to the prescribed schedule. In some implementations, the computing device can detect when the user has taken the prescribed medication according to the prescribed schedule and cancel a scheduled reminder. In some implementations, the computing device can remind the user to take the prescribed medication when the computing device detects that the user is near the medication container device. In some implementations, the computing device can remind the user to take the prescribed medication when the computing device detects symptoms associated with the prescribed medication.

### TECHNICAL FIELD

The disclosure generally relates to managing a user's prescription schedule.

### BACKGROUND

Many people take medications for a variety of reasons or to treat a variety of medical conditions. A person can take medication to manage blood pressure, to manage pain, or to manage cholesterol levels, for example. Typically, a doctor will prescribe a medication to a person to be taken according to a schedule. For example, the schedule and dosage (e.g., amount of medication to take) prescribed by the doctor can be formulated in order to maintain an appropriate amount of the medication in the person's body to treat the person's medical condition. If the person does not adhere to the prescription schedule and dosage, the person may experience or suffer from the medical condition that the person is seeking to avoid.

### SUMMARY

in some implementations, a computing device can receive a prescription for a user from a medication container device. The container device can be encoded with the prescription and can transmit the prescription (e.g., medication schedule and dosage information) to the computing device. The computing device can schedule presentation of reminders for the user to take the prescribed medication according to the prescribed schedule. In some implementations, the computing device can detect when the user has taken the prescribed medication according to the prescribed schedule and cancel a scheduled reminder. In some implementations, the computing device can remind the user to take the prescribed medication when the computing device detects that the user is near the medication container device. In some implementations, the computing device can remind the user to take the prescribed medication when the computing device detects symptoms associated with the prescribed medication.

Particular implementations provide at least the following advantages: the user will not be burdened with manually entering the prescription into the user's computing device; the user will be less likely to forget to take medications according to the prescribed schedule; the user will not be burdened with reminders to take the prescribed medication when the user has already taken her medication; and the user will be less likely to forget to eat before taking medications that require food.

Details of one or more implementations are set forth in the accompanying drawings and the description below. Other features, aspects, and potential advantages will be apparent from the description and drawings, and from the claims.

### DESCRIPTION OF DRAWINGS

FIG. 1 is a block diagram of an example system for improving medication adherence.

FIG. 2 illustrates an example graphical user interface for confirming the receipt of a new prescription.

FIG. 3 illustrates an example graphical user interface confirming that the prescription has been saved.

FIG. 4 illustrates an example graphical user interface for presenting a prescription reminder.

FIG. 5 illustrates an example graphical user interface for presenting a prescription reminder based on detected symptoms.

FIG. 6 illustrates an example graphical user interface for notifying the user of an alternate prescription schedule.

FIG. 7 is flow diagram of an example process for intelligently reminding a user to take a prescribed medication.

FIG. 8 is a flow diagram of an example process for presenting, a prescription reminder based on proximity to a prescription container device.

FIG. 9 is a flow diagram of an example process for presenting a prescription reminder based on a user's symptoms.

FIG. 10 is a block diagram of an example computing device that can implement the features and processes of FIGS. 1-9.

Like reference symbols in the various drawings indicate like elements.

### DETAILED DESCRIPTION

### Overview

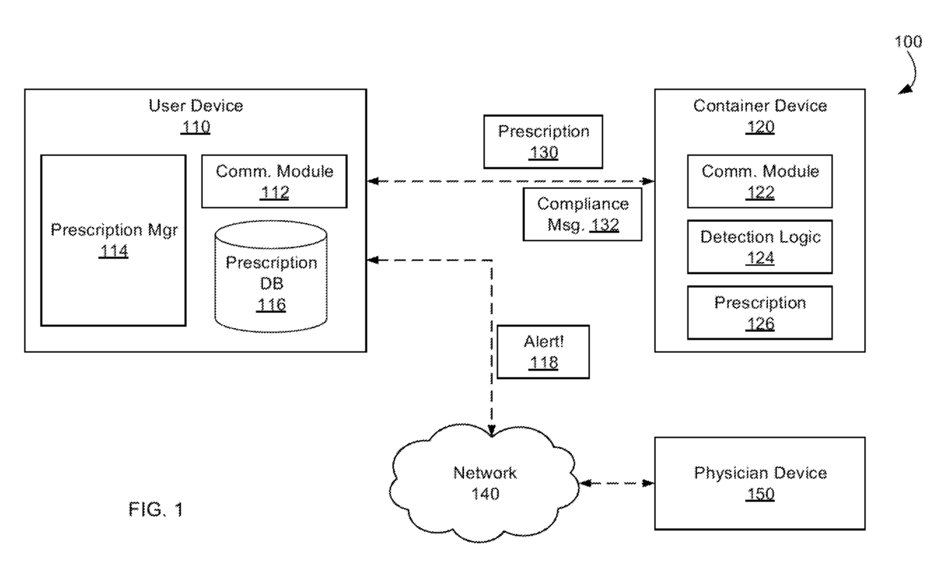

FIG. 1 is a block diagram of an example system 100 for improving medication adherence. For example, system 100 can help a user to remember to take medications according to a prescribed schedule without burdening the user with prescription data entry and excessive reminders. In some implementations, system 100 can include user device 110. For example, user device 110 can be a computing device, such as a laptop computer, smartphone, tablet computer, or other mobile device. User device 110 can be a wearable device, such as a smartwatch, smart eye glasses, or other wearable device.

In some implementations, user device 110 can be configured to receive a prescription from container device 120. For example, container device 120 can be a computing device having built-in medication container compartments and specifically built for managing prescription medications. Container device 120 can be a standard medication container (e.g., plastic bottle) having a smart label adhered to the container. For example, the smart label can include a circuit or microchip programmed or configured with prescription information and capable of transmitting the prescription information to user device 110 and performing other container device functions, as described below.

In some implementations, container device 120 can be programmed with a medication prescription. For example, when a user visits a doctor and receives a prescription for a medication to treat a medical condition of the user, the prescription can be transmitted to a pharmacy where the prescription will be filled. When the pharmacy fills the prescription, the pharmacy can program or configure the container device 120 with the prescription information. The prescription information can be stored by container device 120 as prescription 126.

In some implementations, prescription 126 can include medication schedule and dosage information. For example, prescription 126 can include a prescription identifier. The prescription identifier can be the name of the prescribed medication. The prescription identifier can be an identifier assigned by the pharmacy or the user's doctor, for example. The medication schedule can specify when the user should take a dose of the prescribed medication. The medication schedule can specify that the user should take the medication on a regular schedule (e.g., one dose a day, one dose every four hours, etc.). The medication dosage information can specify how much of the prescribed medication the user should take. For example, the dosage information can specify that the user should take 28 mg of the prescribed medication according to the prescribed schedule (e.g., every 24 hours).

In some implementations, prescription 126 can indicate that the prescribed medication should be taken with food. For example, some medications are better absorbed by the body when taken with food. Some medications may upset the user's stomach if not taken with food. Thus, prescription 126 can indicate that the user should take the prescribed medication with food and/or specify a period of time 30 minutes, 1 hour, etc.) before taking the prescribed medication when the user should eat. In some implementations, prescription 126 can identify other medications that should not he taken with the medication prescribed by prescription 126. For example, if prescription 126 prescribes an antihistamine medication, then prescription 126 can identify interacting drugs or medications (e.g., such as a blood pressure medication) that the user should not take with the prescribed antihistamine.

In some implementations, prescription 126 can indicate alternate prescription schedules. For example, prescription 126 can include information describing how to adjust the prescription schedule and/or dosage if the user misses a scheduled dosage or does not otherwise comply with the prescription (e.g., takes too small of a dose). The alternate schedule can indicate a different dosage and/or a different dosage schedule, for example. In some implementations, prescription 126 can include symptom information. For example, prescription 126 can describe symptoms of the user's condition that the medication was prescribed to treat. The symptom information can be used to determine when the user has missed a scheduled dosage of the medication, for example.

In some implementations, container device 120 can transmit prescription 126 to user device 110. For example, container device 120 can transmit prescription 126 in to user device 112 in prescription message 130. In some implementations, prescription message can include an identifier corresponding to container device 130. Container device 120 can transmit prescription message 130 to user device 110 using communication module 122. For example, container device 120 can include communication module 122. Communication module 122 can be a processor, radio frequency device (e.g., Wi-Fi radio, Bluetooth radio, radio frequency identification reader, etc.), or other communication device. Communication module 122 can be a circuit embedded in a label attached to container device 12, for example.

In some implementations, user device 110 can receive prescription message 130 using communication module 112. For example, communication module 112 can be a processor, radio frequency device (e.g., Wi-Fi radio, Bluetooth radio, radio frequency identification reader, etc.), or other communication device. Communication module 122 of container device 120 can communicate with communication module 112 of user device 110 using various communication protocols and/or technologies. For example, communication module 122 of container device 120 can communicate with communication module 112 of user device 110 using Wi-Fi, Bluetooth, Bluetooth LE, (low energy), radio-frequency identification (RFID) technologies, automatic identification and data capture (AIDC) technologies, and/or other near-field communication technologies.

In some implementations, container device 120 can transmit prescription. message 130 when container device 120 is near user device 110. For example, when a near field communication technology (NFC) is used to transmit prescription message 130 from container device 120 to user device 110, container device 120 can transmit prescription message 130 in response to receiving a (e.g., Bluetooth, RFID, etc.) radio signal from user device 110. When other wireless networking technologies are used (e.g., Wi-Fi, radio access technologies, etc.). container device 120 can transmit prescription message 130 when a connection is established between container device 120 and user device 110 through a network (e.g., local area network, wide area network, internet, etc.).

In some implementations, container device 120 can transmit prescription. message 130 to user device 110 when the user of user device 110 is authorized to receive the prescription information. For example, when container device 120 is a smart container device (e.g., a computing device), container device 120 can authenticate the user of user device 110 by requesting the identification of the user and a security token (e.g., password). Once the user is authenticated, container device 120 can compare the user's identification to the patient identified in the prescription to determine if the authenticated user is the user for whom the prescription was written.

In some implementations, prescription message 130 can be secured using physical security techniques. For example, when the prescription is encoded into a prescription label using NFC technologies, if the user has physical control over the prescription container and can read the prescription label with user device 110, then the user will have access to the prescription information. Since user device 110 must be near the label on the prescription container to read the prescription, the user can prevent others from reading the prescription using physical access control mechanisms (e.g., physically secure the container where others cannot access it).

In some implementations, user device 114 can include prescription manager 114. For example, prescription manager 114 can be a process, utility, or function, of the operating system of user device 110. Prescription manager 114 can he a standalone software application installed and/or running on user device 110. When container device 120 communicates prescription message 130 to user device 110, prescription manager 114 can obtain prescription 126 from prescription message 130 received by communication module 112. In some implementations, prescription manager 114 can present a notification confirming receipt of prescription 126.

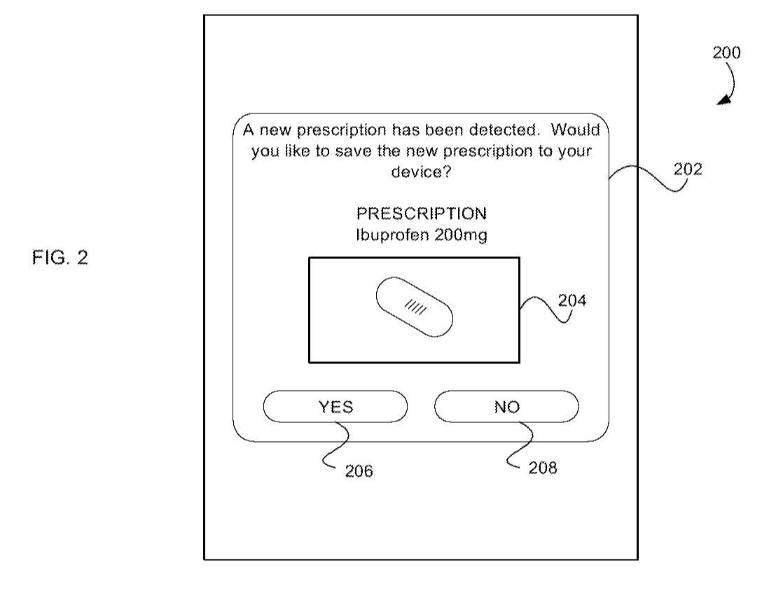

FIG. 2 illustrates an example graphical user interface 200 for confirming the receipt of a new prescription. For example, prescription manager 114 can present graphical user interface (GM) 200 on a display of user device 110 in response to receiving prescription message 130 and/or prescription 126. In some implementations, GUI 200 can include notification 202.

In some implementations, notification 202 can describe prescription 126. For example, notification 202 can present a textual description of the prescription that identifies the prescribed medication and the prescribed dosage. Notification 202 can present a graphical description of the prescription. For example, notification 202 can include image 204 that represents what the prescribed medication looks like. In some implementations, notification 202 can ask the user whether the user would like to save prescription 126 to user device 110. The user can select graphical element 206 (e.g., a button) to cause prescription manager 114 to save the prescription to prescription database 116 and schedule reminders for the prescription. The user can select graphical element 208 to cause prescription manager 114 to discard (e.g., delete) the prescription from user device 110.

Returning to FIG. 1, in some implementations, prescription manager 114 can store the prescription information corresponding to prescription 126 in prescription database 116. For example, prescription manager 114 can store the container device identifier, prescription identifier, prescription schedule, prescription dosage information, and/or other prescription information related to prescription 125 in prescription database 116. Prescription database 116 can store prescription 126 as one of many prescription records associated with the user, for example.

In some implementations, prescription manager 114 can determine whether a prescribed, medication conflicts with other medications prescribed for the user. For example, when prescription manager 114 receives prescription 126, prescription manager 114 can compare the medications identified in prescription 126 as interacting drugs to the other medications that have been prescribed to the user and stored in prescription database 116. For example, if prescription 126 prescribes an antihistamine medication and identifies an interaction with a blood pressure medication, prescription manager 114 can compare the blood pressure medication to the user's prescriptions stored in prescription database 116 to determine if the user has a current prescription for the identified blood pressure medication. If prescription database 116 includes the identified blood pressure medication, prescription manager 116 can present a notification describing the interaction. For example, the notification can prompt the user to contact the user's physician to discuss the potential interaction.

In some implementations, upon receipt of prescription 126, prescription manager 114 can schedule reminders to present to the user according to the prescribed schedule. For example, the reminders can present a message to the user on a display of user device 110 that reminds the user to take a dose of the prescribed medication at a particular time, according to the prescribed schedule.

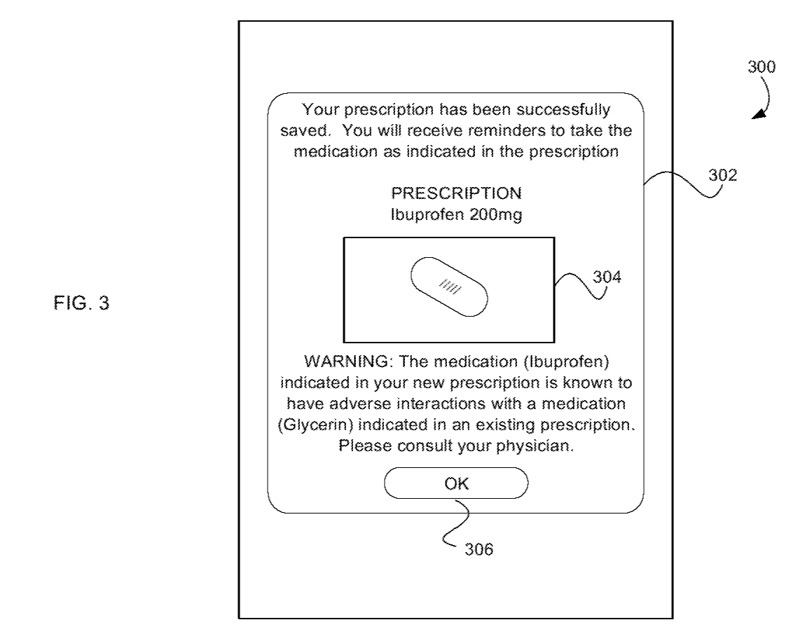

FIG. 3 illustrates an example graphical user interface 300 confirming that the prescription has been saved to user device 110. For example, GUT 300 can be presented by prescription manager 114 on a display of user device 110 after prescription 126 has been saved and/or the prescription reminders have been scheduled. In some implementations, GUI 300 can include notification 302. Notification 302 can include a textual confirmation that the prescription has been saved and/or prescription reminders have been scheduled. Notification 302 can include a textual description of the prescribed medication (e.g., medication name, dosage amount, etc.). Notification 302 can include an image representing the appearance of the prescribed medication.

In some implementations, notification 302 can include a warning about drug interactions. For example, when prescription manager 114 determines that a potential drug interaction exists between the medication identified in prescription 126 and a medication that the user is already taking, prescription manager 114 can include a warning and/or a description of the interaction on notification 302. The user can dismiss notification 302 by selecting graphical element 306 (e.g., a button).

Returning to FIG. 1, in some implementations, prescription manager 114 can start the prescription schedule based on when the prescription is received by prescription manager 114. For example, prescription manager 114 can start the prescription schedule and/or present the first reminder upon receipt of the prescription information from prescription manager 114.

In some implementations, prescription manager 114 can start the prescription schedule upon determining that the user has taken a prescribed dosage. For example, prescription manager 114 can receive prescription compliance message 132 from container device 120 indicating that the user has taken a dose of the prescribed medication. In some implementations, the user can provide user input to user device to indicate that the user has taken the first dose of the prescribed medication. For example, prescription manager 114 can present a graphical user interface that receives input from the user indicating that the user has taken a dose of the prescribed medication. In response to receiving the indication that the user has taken the first dose of the prescribed medication, prescription manager 114 can notify prescription manager 114 that the user has taken the medication. Prescription manager 114 can start the prescription schedule in response to receiving the notification. For example, since the user has already taken the first dose of the medication, prescription manager 114 can schedule a reminder for the second dose according to the prescribed schedule.

### Determining Compliance

in some implementations, prescription manager 114 can automatically determine whether the user has complied with a prescription schedule. For example, rather than relying upon user input to determine when the user has taken a dose of the prescribed medication according to the prescribed schedule, prescription manager 114 can automatically determine (e.g., without user input to user device 110) that the user has taken the prescribed medication according to the prescribed schedule.

In some implementations, prescription manager 114 can determine whether the user has complied with a prescription schedule based on detecting a compliance activity performed by the user. For example, the compliance activity can include the user moving or lingering near container device 120. The compliance activity can include the user interacting with (e.g., opening) container device 120, for example. The compliance activity can include user input to user device 110 that indicates that the user took the prescribed medication.

In some implementations, prescription manager 114 can automatically determine that the user has taken the prescribed medication based on the proximity (e.g., nearness) of user device 110 to container device 120. For example, prescription manager 114 can detect a compliance activity when the user moves user device 110 near container device 120. In some implementations, proximity can be determined using short range communication technologies. For example, certain communication technologies (e.g., NFC, Bluetooth, RFID, etc.) require that two communicating devices be near each other (e.g., 1 foot, 10 centimeters, etc.) for a communication connection and/or session to be established. User device 110 and container device 120 can be configured to communicate with each other using one or more of these short range communication technologies. When the user device 110 moves close enough to container device 120 to establish a connection when the user taps user device 110 on container device 120), prescription manager 114 can determine that user device 110 is proximate (e.g., near) to container device 120. in response to determining that user device 110 is proximate to container device 120, prescription manager 114 can determine that the user has taken the prescribed medication. For example, upon establishing the connection to container device 120, prescription manager 114 can receive from container device 120 an identifier corresponding to the prescription medication stored by container device 120. Alternatively, prescription manager 114 can receive an identifier corresponding to container device 120. Prescription manager 114 can determine which medication the user took by comparing the prescription identifier or the container identifier to the prescription records in in prescription database 116.

In some implementations, prescription manager 114 can automatically determine that the user has taken a prescribed medication when user device 110 lingers near container device 120 for a period of time. For example, prescription manager 114 can detect a compliance activity when the user moves user device 110 near container device 120 and lingers near container device 120 for a period of time. For example, when prescription manager 114 determines that user device 110 has remained (e.g., lingered) near container device 120 for a period of time (e.g., long enough to take the prescribed medication, 1 minute, 2 minutes, etc.), then prescription manager 114 can determine that the user has taken the prescribed medication.

In some implementations, prescription manager 114 can automatically determine that the user has taken the prescribed medication based on a compliance message received from container device 120. For example, container device 120 can send a compliance message to prescription manager 114 when detection logic 124 of container device 120 detects a compliance activity, such as opening the medication compartment of container device 120. For example, detection logic 124 can include circuitry for detecting when the medication compartment of container device 120 has been opened. When detection logic 124 detects that the medication compartment of container device 120 has been opened, detection logic 124 can send (e.g., transmit, wirelessly communicate, etc.) compliance message 132 to prescription manager 114 indicating that the user has opened the medication compartment of container device 120.

In some implementations, compliance message 132 can include an identifier for the prescribed medication stored in the medication compartment of container device 120 and the time at which the user opened the medication compartment. For example, prescription manager 114 of user device 110 can use the medication identifier to identify the prescription in prescription database 116 corresponding to prescription compliance message 132. In some implementations, compliance message 132 can include an identifier for container device 120 and the time at which the user opened the medication. compartment of container device 120. For example, prescription manager 114 of user device 110 can use the container identifier to identify the prescription in prescription database 116 corresponding to prescription compliance message 132. Upon receipt of compliance message 132, prescription manager 114 can determine that the user has taken the prescribed medication identified by the compliance message at the time indicated in compliance message 132.

In some implementations, container device 120 can include multiple container compartments each containing a different prescribed medication. For example, container device 120 can be configured with information identifying the prescribed medication in each compartment. Compartment #1 can store prescription #1, for example. Compartment #2 can store prescription #2, for example. When a user opens compartment #1 to take the medication corresponding to prescription #1, container device 120 can detect that compartment #1 was opened and send compliance message 132, including an identifier for prescription #1 and a timestamp identifying when compartment #1 was opened. Upon receipt of compliance message 132, prescription manager 114 can determine that the user has taken the prescribed medication identified by the compliance message (e.g., by prescription identifier, by container identifier) at the time indicated in compliance message 132.

### Verifying the User Took Medication

In some implementations, container device 120 can send compliance message 132 after verifying that the user took the prescribed medication. For example, container device 120 can verify that the user actually took the prescribed medication after detecting a compliance activity by taking an inventory of medication units (e.g., pills, tablets, etc.) stored in container device 120.

In some implementations, container device 120 can verify the user actually took a medication based on the weight of medications in container device 120. In some implementations, container device 120 can include a weight sensor that can detect the total weight of pills in container device 120 before a compliance activity and after a compliance activity, as described above. For example, if the total weight of the pills in container device 120 after the compliance activity is the same as the total weight before the compliance activity, the user did not actually take the prescribed medication. If the total weight of the pills after the compliance activity is less than as the total weight before the compliance activity, container device 120 can confirm that the user actually took the prescribed medication. In some implementations, container device 120 can send compliance message 132 to prescription manager 114 when container device 120 confirms that the user actually took the prescribed medication.

In some implementations, container device 120 can verify the user actually took a medication based on a radio frequency identifier attached to the prescribed medication stored in container device 120. For example, an RFID tag can be attached to each medication unit stored in container device 120. Each RFID tag can have a corresponding unique identifier. Container device 120 can read (e.g., detect) each RFID tag to determine an identifier for each pill. Container device 120 can determine how many pills are stored in container device 120 based on how many RFID tags container device 120 has read. For example, the number of RFID tags read by container device 120 can correspond to the number of pills stored in container device 120.

In some implementations, container device 120 can determine whether the user has taken a prescribed medication by comparing the number of pills detected before the compliance activity to the number of pills detected after the compliance activity. If the number of pills detected decreased after the compliance activity, then container device 120 can confirm that the user actually took the prescribed medication. In some implementations, container device 120 can send compliance message 132 to prescription manager 114 when container device 120 confirms that the user actually took the prescribed medication.

In some implementations, prescription manager 114 can verify the user actually took a medication based on an image of the medications in container device 120. For example, container device 120 can include tube shaped compartments where the prescribed medication units (e.g., pills, tablets, etc.) are stacked on top of each other. The compartments can be transparent or semi-transparent so that the medication can be viewed from outside the compartments. A user can use a camera application on user device 110 to take a picture of the medication in the compartments. Prescription manager 114 can analyze the picture of the medication in the compartments to determine whether the user took the prescribed medication. For example, prescription manager 114 can compare a picture of the medication compartment taken before a compliance activity to a picture of the medication compartment taken after the compliance activity. Prescription manager 114 can determine whether there is a change in the number of pills in the compartment based on the comparison of the before and after pictures. If there is a change in the number of pills, prescription manager 114 can confirm that the user actually took the prescribed medication.

### Determining User Took Correct Dosage

In some implementations, prescription manager 114 can determine whether the user took the correct dosage based on compliance message 132. For example, compliance message 132 can indicate the amount (e.g., dosage) of the prescribed medication the user actually took. Prescription manager 114 can compare the amount to the prescribed dosage to determine whether the user took to correct amount. For example, if the prescription prescribes one 200 mg pill of the prescribed medication and the compliance message indicates the user took two 400 mg pills, then prescription manager 114 can determine that the user did not comply with the prescription schedule and/or dosage. If the prescription, prescribes one 200 mg pill of the prescribed medication and the compliance message indicates the user took one 200 mg pills, then prescription manager 114 can determine that the user complied with the prescription schedule and/or prescribed dosage.

In some implementations, container device 120 can determine how much of the prescribed medication the user took based on the weights of the pills in container device 1120. For example, prescription 126 can prescribe a medication schedule that requires the user to take one 200 mg pill per dose. If each pill weighs 200 milligrams (mg) and the weight of the pills in container device 120 before a compliance activity is 1000 mg, then container device 120 can determine that there were 5 pills in the container 1000 mg/200 mg 5 pills) before the compliance activity. If the weight of the pills in container device 120 is 800 mg after the compliance activity, then container device 120 can determine that the user took the correct dosage of 1 pill (e.g., 200 mg). If the weight of the pills in container device 120 is 600 mg after the compliance activity, then container device 120 can determine that the user took an incorrect dosage of 2 pills (e.g., 400 mg). In some implementations, container device 121) can indicate the dosage actually taken by the user in compliance message 132. For example, if container device 120 determines that the user took a 400 mg dose of the prescribed medication, container device 120 can indicate in compliance message 132 that the user took 400 mg of the prescribed medication.

in some implementations, container device 120 can determine how much of the prescribed medication the user took based on the REED tags of the pills in container device 120. For example, prescription 126 can prescribe a medication schedule that requires the user to take one 200 mg pill per dose. Container device 120 can determine how many pills were in container device 120 before the compliance activity by counting the detected RFID tags attached to the pills. Container device 120 can determine how many pills were in container device 120 after the compliance activity by counting the detected REED tags attached to the pills. If the number of the pills in container device 120 was 30 before the compliance activity and the number of the pills in container device 120 was 29 after the compliance activity, then container device 120 can determine that the user took the correct dosage of 1 pill (e.g., 200 mg). If the number of the pills in container device 120 was 30 before the compliance activity and the number of the pills in container device 120 was 28 after the compliance activity, then container device 120 can determine that the user took an incorrect dosage of 2 pills (e.g., 400 mg). In some implementations, container device 120 can indicate the dosage actually taken by the user in compliance message 132. For example, if container device 120 determines that the user took 2 pills (e.g., a 400 mg dose of the prescribed medication), container device 120 can indicate in compliance message 132 that the user took 2 pills or 400 mg of the prescribed medication.

in some implementations, prescription manager 114 can determine whether the user took the correct dosage based on an image of container device 120. For example, prescription manager 114 can capture an image of container device 120 before the compliance activity. Prescription manager 114 can capture an image of container device 120 after the compliance activity. Prescription manager 114 can compare the before image to the after image to determine an amount (e.g., number of pills, weight of medication) of the prescribed medication the user took. Prescription manager 114 can compare the determined, amount to the dosage prescribed in the prescription to determine whether the user took to correct amount. For example, if the prescription prescribes one 200 mg pill of the prescribed medication and the user device determined the user took two 400 mg pills based on the images, then prescription manager 114 can determine that the user did not comply with the prescription schedule and/or dosage. If the prescription prescribes one 200 mg pill of the prescribed medication and the user device determined the user took one 200 mg pill based on the images, then prescription manager 114 can determine that the user complied with the prescription schedule and/or prescribed dosage.

In some implementations, prescription manager 114 can determine how much of the prescribed medication the user took based on an image of the pills in container device 120. For example, the user can capture an image of pills in container device 120 before the compliance activity and after the compliance activity, as described above. Prescription manager 114 can determine how many pills were in container device 120 by measuring the volume or height of pills in container device 120. For example, if the pills are stacked in a tube shaped container, the height of the pills in the tube can correspond to the number of pills in the tube. If each pill is 2 cm thick and the pills are stacked 20 cm high, then prescription manager 114 can determine that there are 10 pills in container device 120. In some implementations, the tube shaped container can have measurement markings that indicate a height or volume. When prescription manager 114 captures an image of the container, prescription manager 114 can determine the height of the stack of pills based on the markings. For example, if the pills are stacked as high as the 20 cm marking on the tube shaped container, then prescription manager 114 can extract the markings from the image (e.g., using optical character recognition technology) and determine that there are 10 pills in the container (e.g., 20 cm/2 cm=10 pills).

If the number of the pills in container device 120 was 20 before the compliance activity and the number of the pills in container device 120 was 19 after the compliance activity, then prescription manager 114 can determine that the user took the correct dosage of 1 pill (e.g., 200 mg). If the number of the pills in container device 120 was 20 before the compliance activity and the number of the pills in container device 120 was 18 after the compliance activity, then prescription manager 114 can determine that the user took an incorrect dosage of 2 pills (e.g., 400 mg).

### Intelligently Presenting Reminders

In some implementations, prescription manager 114 can intelligently present reminders based on user compliance with a prescribed schedule. For example, when prescription manager 114 receives prescription 126 that specifies a prescription schedule and a prescription dosage (e.g., 200 mg once a day), prescription manager 114 can schedule reminders (e.g., notifications) to be presented to the user to remind the user to take the prescribed dosage of medication according to the prescribed schedule. For example, if the prescription specifies that the user should take 200 mg of a medication every 24 hours and the user took a 200 mg dose at 9 am, prescription manager 114 can schedule the next reminder for 9 am the following day. Similarly, if the prescription specifies that the user should take 200 mg of a medication every 12 hours and the user took a 200 mg dose at 8 am, prescription manager 114 can schedule the next reminder for pm the same day.

In some implementations, prescription manger 114 can schedule reminders to eat food before taking a prescribed medication. For example, if prescription 126 specifies that the user should eat 30 minutes before taking a prescribed medication, then prescription manager 114 can schedule a reminder to eat food 30 minutes before the corresponding prescription reminder. For example, if the prescription schedule requires the user to take the prescribed medication at 3 pm and to eat food 30 minutes before taking the medication, then prescription manager 114 can schedule a reminder for the user to eat at 2:30 pm.

In some implementations, prescription manager 114 can schedule reminders for several different prescriptions. For example, prescription manager 114 may receive several different prescriptions that specify different prescription schedules and dosage for different medications. Thus, prescription manager 114 can schedule and present reminders for many different prescriptions.

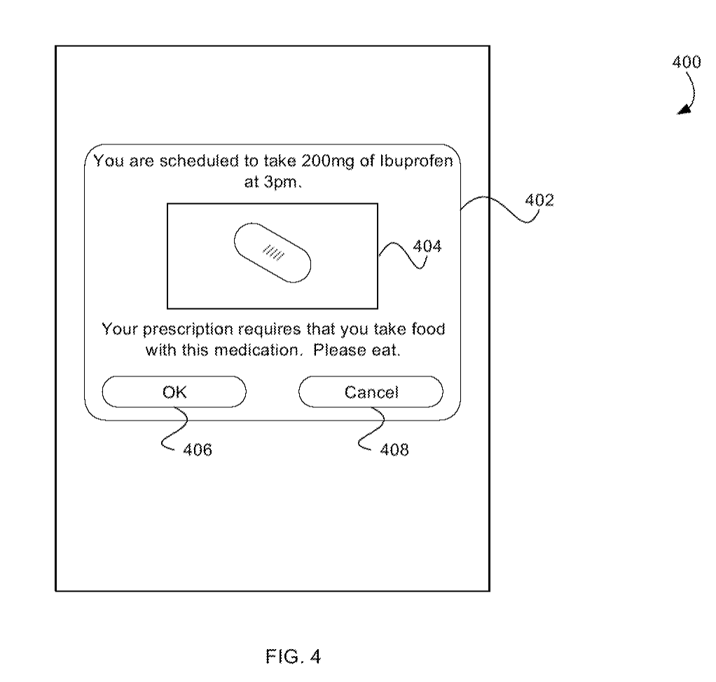

FIG. 4 illustrates an example graphical user interface 400 for presenting a prescription reminder. For example, GUI 400 can be presented on a display of user device 110. GUI 400 can include notification 402. Notification 402 can be a prescription reminder generated by prescription manager 114, for example. Notification 402 can include a textual description of the prescribed medication (e.g., identification of the medication, dosage amount, etc.). Notification 402 can include image 404 representing the appearance of the prescribed medication. For example, the user can confirm that she is taking the correct medication by comparing image 404 to the appearance of the medication the user is about to take. Notification 402 can include a reminder to take food before taking the prescribed medication if required by prescription 126. The user can dismiss notification 402 by selecting, graphical element 406 (e.g., a button) or graphical element 408. In some implementations, selection of graphical element 406 can be interpreted by prescription manager 114 as a confirmation that the user took the prescribed, medication in compliance with prescription 126. In some implementations, selection of graphical element 408 dismisses notification 402 (e.g., removes notification 402 from view on GUI 400) without confirming that the user took the prescribed medication.

Returning to FIG. 1, in some implementations, prescription manager 114 can cancel a prescription reminder based on a detected compliance activity. For example, prescription reminders are intended to help forgetful users to remember to take their prescribed medications according to the prescribed schedule. If the user's prescription indicates that the user should take the prescribed medication every 24 hours and the user started the prescription schedule at 8 am, then a reminder can be scheduled for 8 am every day. However, presenting a prescription reminder can be a nuisance when the user remembers to take the prescribed medication according to the prescribed schedule before the reminder is presented.

In some implementations, prescription manager 114 can cancel a prescription reminder when prescription manager 114 determines that the user has complied with the prescription schedule. For example, prescription manager 114 can determine that the user has complied with the prescription schedule by determining that the user has performed a compliance activity related to the prescription corresponding to the prescription reminder within a period of time (e.g., 5 minutes, 10 minutes, etc.) before the prescription reminder is scheduled to be presented, as described above. Prescription manager 114 can determine that the user has complied with the prescription schedule by confirming that the user actually took the prescribed medication, as described above. Prescription manager 114 can determine that the user has complied, with the prescription schedule by determining that the user took the correct dosage of the prescribed medication, as described above.

In some implementations, when prescription manager 114 determines that the user has complied with the prescription schedule, prescription manager 114 can cancel the currently scheduled reminder and schedule the next reminder according to the prescribed schedule. For example, if the prescription prescribes one 200 mg dose of the prescribed medication every 24 hours and the canceled reminder was scheduled for 8 am, prescription manager 114 can schedule the next reminder (e.g., a new reminder) for 8 am the following day.

In some implementations, prescription manager 114 can present a prescription reminder in response to determining that user device 110 is near container device 120. For example, it would be convenient for the user to take the prescribed medication when the user is already near container device 120 (as indicated by the proximity of user device 110 to container device 120). Thus, prescription manager 114 can present the prescription reminder to the user when prescription manager 114 determines that user device 110 is near container device 120. In some implementations, prescription manager 114 can determine that user device 110 is near container device 120 based on signals received from container device 120. For example, NFC, Bluetooth, Bluetooth low energy, and/or other short range communication technologies can be used by container device 120 to communication with user device 110. Since these communication technologies require user device 110 to be within a short distance of container device 120 to receive a signal from container device 120, prescription manger 114 can determine that user device 110 is near container device 120 when one of these short range signals are received.

In some implementations, prescription manager 114 can determine that user device 110 is near container device 120 when user device 110 is within a threshold distance (e.g., 5 feet, 10 feet, etc.) of container device 120. For example, the location of container device 120 and/or user device 110 can be determined using various well-known location technologies (e.g., satellite location technologies, cellular location technologies, Wi-Fi location technologies, etc.). User device 110 can receive container device location information describing the location of container device 120 and compare the location of user device 110 to the location of container device 120 to determine whether user device 110 is within a threshold distance of container device 120.

In some implementations, prescription manager 114 can present a prescription reminder in response to determining that user device 110 is near container device 120 within a period of time of a scheduled prescription reminder. For example, a user should not take a prescribed medication just because she is near prescription container 120. The user should take the prescribed medication at the appropriate time (e.g., according to the prescribed schedule). Thus, prescription manager 114 can present a prescription reminder when prescription manager 114 determines that the user (e.g., user device 110) is near prescription container 120 at a time that is within a period, of time (e.g., 5 minutes, 8 minutes, etc.) of a scheduled reminder. For example, prescription manager 114 can present the prescription, reminder notification illustrated by FIG. 4. Thus, the user can be reminded to take the prescribed medication when the user is conveniently near prescription container 120 and at an appropriate time.

In some implementations, prescription manager 114 can present a prescription reminder in response to detecting symptoms associated with a prescribed medication. For example, when prescription manager 114 receives prescription 126, prescription 126. can include information describing symptoms associated with conditions the prescribed medication is prescribed to treat. In some implementations, user device 110 can be configured with sensors that can detect a user's symptoms. For example, user device 110 can include a motion sensor (e.g., accelerometer) that can detect hand shaking, tremors, or other symptoms that present through movement of the user's body. User device 110 can include a heart rate and/or breathing rate sensor (e.g., a photoplethysmogram sensor, a pulse oximeter, etc.) for detecting heart rate, breathing rate, and/or irregularities with respect to heart rate and/or breathing rate. User device 110 can include a dehydration sensor (e.g., a photoplethysmogram sensor) to detect when the user is dehydrated. When user device 110 detects movement, heart rate, breathing rate, and/or dehydration symptoms, prescription manager 114 can compare the detected symptoms to the symptoms described in prescription 126 to determine if the detected symptoms match the symptoms described m prescription 126. When prescription manager 114 determines that one of the detected symptoms matches (e.g., corresponds to) one of the symptoms described, in prescription 126, prescription manager 114 can present a reminder for the user to take the medication prescribed by prescription 126. For example, if the user is exhibiting one or more of the symptoms described, in prescription 126, then the user may have forgotten to take the medication prescribed in prescription 126. Thus, prescription manager 114 can use the user's symptoms to remind the user to take the prescribed medication.

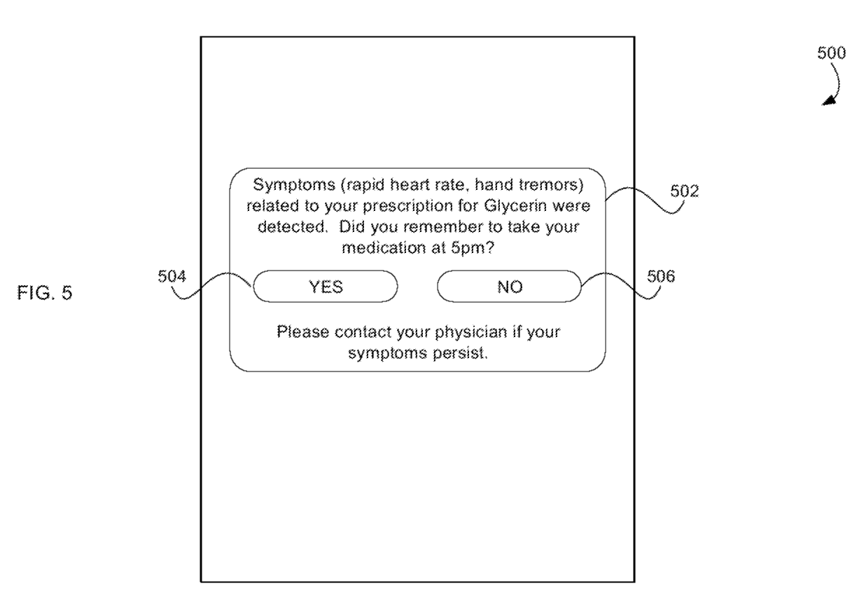

FIG. 5 illustrates an example graphical user interface 500 for presenting a prescription reminder based on detected symptoms. GUI 500 can be presented on a display of user device 110, for example. In some implementations, GUI 500 can include prescription reminder 502. For example, prescription reminder 502 can be presented by prescription manager 114 in response to prescription manager 114 detecting symptoms related to prescription 126. For example, prescription 126 can be prescribed by a doctor to treat a condition that presents with the symptoms of rapid heart rate, hand tremors, etc. When prescription manager 114 detects that the user is exhibiting a rapid heart rate and/or hand tremors, prescription manager 114 can compare the detected symptoms to the symptoms described in prescription 126 to determine if the detected symptoms are related to prescription 126. When prescription manager 114 determines that the detected symptoms are related to prescription 125, prescription manager 1114 can present notification 502 to remind the user to take the medication prescribed in prescription 126.

In some implementations, notification 502 can include a description of the symptoms, a description of the prescribed medication, and/or a reminder to take the prescribed medication, for example. In some implementations, notification 502 can include a suggestion to contact the user's physician. In some implementations, notification 502 can include graphical element 504. For example, the user can select graphical element 504 to indicate to prescription manager 114 that the user took the prescribed medication according to the prescribed schedule. In some implementations, notification 502 can include graphical element 506. For example, the user can select graphical element 506 to indicate to prescription manager 114 that the user did not take the prescribed medication according to the prescribed schedule (e.g., the user has not complied with the prescription).

In some implementations, prescription manager 114 can present reminders in a variety of ways. For example, if a prescription reminder is scheduled for 8 am, prescription manager 114 can determine that the current time is 8 am and present the prescription reminder to the user. Prescription manager 114 can present the reminder visually. For example, prescription manager 114 can present a graphical notification (e.g., including textual data, images, etc.) on a display of user device 110. Prescription manager 114 can present the reminder audibly. For example, prescription manager 114 can cause user device 110 to generate a sound (e.g., alarm) to draw the user's attention to a graphical notification presented by user device 110. Prescription manager 114 can present the reminder using a haptic notification. For example, prescription manager 114 can cause user device 110 to generate a vibration to draw the user's attention to a graphical notification presented by user device 110.

### Handling Non-Compliance

In some implementations, prescription manager 114 can be configured to handle a user's non-compliance, with a prescription. For example, prescription manager 114 can determine the user's non-compliance when a user misses a scheduled dosage of the prescribed medication when the user fails to perform, or prescription manager 114 fails to detect, a compliance activity, as described above. Prescription manager 114 can determine the user's non-compliance when prescription manager 114 determines that the user took the wrong amount of the prescribed medication, as described above.

In some implementations, prescription manager 114 can implement an alternate prescription schedule when prescription manager 114 determines that the user has not complied with the prescription. For example, prescription 126 can include an alternate prescription schedules defined by a doctor to accommodate the user missing a scheduled dose of the prescribed medication and/or the user taking the wrong amount of the prescribed medication. When prescription manager 114 determines that he user missed a scheduled dose or took the wrong amount of the medication, prescription manager 114 can schedule future reminders according to one of the alternate prescription schedules.

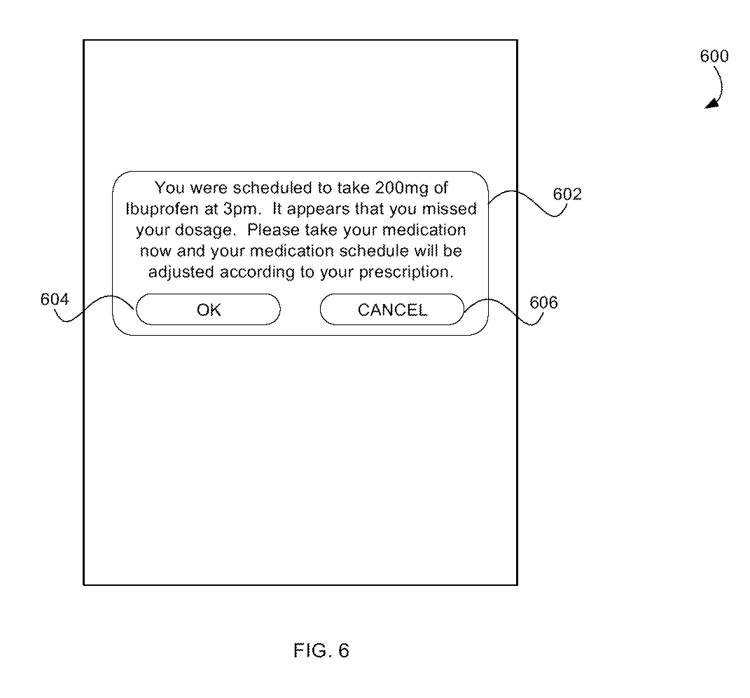

FIG. 6 illustrates an example graphical user interface 600 for notifying the user that an alternate prescription schedule will be implemented by prescription manager 114. For example, GUI 600 can be a presented on user device 110 in some implementations GUI 600 can include notification 602. For example, notification 602. can be a schedule change notification generated by prescription manager 114. Notification 602 can include a description of the schedule change (e.g., the reason why the schedule is being changed, a description of the new schedule, etc.). Notification 602 can include a description of the prescribed medication (e.g., medication identifier, dosage amount, etc.). Notification 602 can include a prompt (e.g., reminder) for the user to take the prescribed medication. In some implementations, notification 602 can include graphical element 604. For example, a user can select graphical element 604 to cause prescription manager 114 to implement the alternate prescription schedule described in notification 602. The user can select graphical element 604 to confirm to prescription manager 114 that the user took the prescribed medication described in notification 602. In some implementations, notification 602 can include graphical element 606. For example, a user can select graphical element 660604 to prevent prescription manager 114 from implementing the alternate prescription schedule described in notification 602. If the user selects graphical element 606, prescription manager 114 will continue to use the current (e.g., original) prescription schedule without adjustment, for example.

In some implementations, prescription manager 114 can notify the user's physician when prescription manager 114 determines that the user has not complied with the prescription. For example, prescription 126 can include contact information (e.g., email address, telephone number, etc.) for the user's physician. When prescription manager 114 determines that the user has not complied with the prescription schedule and/or prescribed dosage specified by prescription 126, prescription manager 114 can notify the user's physician using the contact information provided in prescription 116. For example, prescription manager 114 can send non-compliance alert 118 to physician device 150 through network 140 (e.g., the internet local area network, network, wide area network, etc.) to alert the user's physician to the user's failure to comply with prescription 126.

### Example Processes

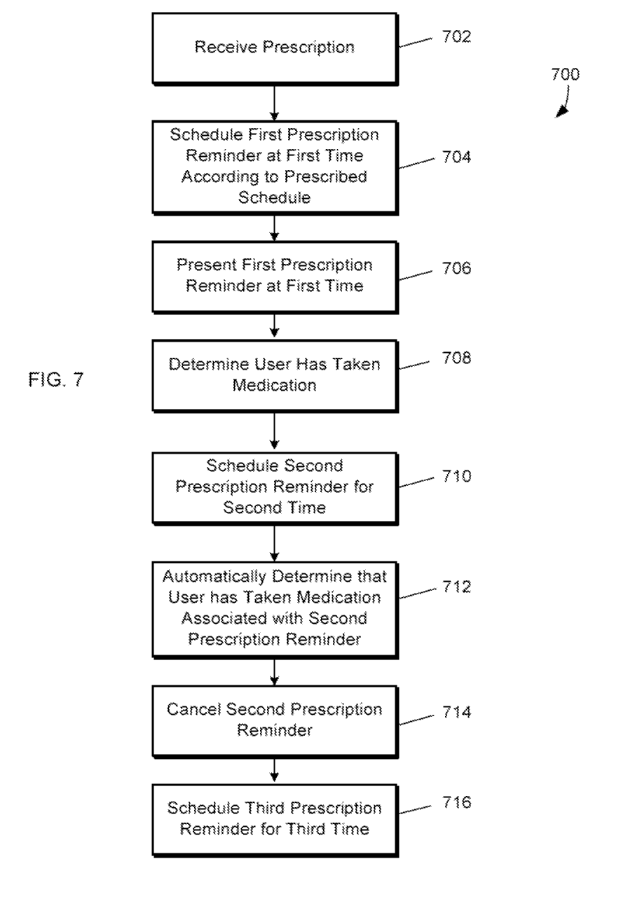

FIG. 7 is flow diagram of an example process 700 for intelligently reminding a user to take a prescribed medication. For example, process 700 can help the user adhere to a medication schedule by reminding the user to take the prescribed medication in a less burdensome or intrusive manner. For example, process 700 can prevent prescription reminders from being presented when the user has already taken the prescribed medication according to the prescribed schedule and/or dosage.

At step 702, user device 110 can receive a prescription. For example, user device 110 can receive a prescription from container device 120, as described above. The prescription can be received when user device 110 is near container device 120, for example. The prescription can be transmitted from container device 120 to user device 110 using NFC, Bluetooth, Bluetooth LE, Wi-Fi and/or other communication technologies. For example, the prescription can identify a prescribed medication, specify a medication dosage amount, and describe a prescribed schedule for taking the prescribed medication.

At step 704, user device 110 can schedule a first prescription reminder at a first time according to a prescription schedule. For example, user device 110 can schedule the first prescription reminder according to the schedule described in the prescription. The user device can schedule the first prescription reminder based on when the prescription was received. For example, user device 110 can prompt the user to take the first dose of the prescribed medication when the prescription was received. User device 110 can receive an indication that the user took the first dose of the medication and schedule the first reminder for the second dose of the prescribed medication at a first time 8 am, 10 pm, etc.) according to the prescribed schedule.

At step 706, user device 110 can present the first prescription reminder at a first prescribed time. For example, user device can present the notification, illustrated in FIG. 4 when user device 110 determines that the current time corresponds to the first time.

At step 708, user device 110 can determine that the user has taken the prescribed medication. For example, user device 110 can automatically determine that the user has taken the prescribed medication when user device 110 determines that the user has performed a compliance activity. User device 110 can determine that the user has taken the prescribed medication when user device 110 confirms that the user has actually taken the prescribed medication and/or has actually taken the prescribed dosage, as described above. User device 110 can determine that the user has taken the prescribed medication when user device 110 receives user input indicating that the user has taken the prescribed medication. For example, user device 110 can determine that the user has taken the prescribed medication in response to receiving user input to dismiss the first prescription reminder.

At step 710, user device 110 can schedule a second prescription reminder for a second time. For example, upon determining that the user has taken the prescribed medication at the first time, user device 110 can schedule the second prescription reminder for the second time according to the prescribed schedule. For example, if the prescription specifies that the user should take the prescribed medication every eight (8) hours, then user device 110 can schedule the second prescription reminder for 8 hours after the first prescription reminder.

At step 712, user device 110 can automatically determine that the user has taken the prescribed medication associated with the second prescription reminder. For example, user device 110 can automatically determine that the user has taken the prescribed medication when user device 110 determines that the user has performed a compliance activity. User device 110 can determine that the user has taken the prescribed medication when user device 110 confirms that the user has actually taken the prescribed medication and/or has actually taken the prescribed dosage, as described above. In some implementations, user device 110 can determine that the user took the prescribed. medication before user device 110 presented the second prescription reminder. For example, user device 110 can determine that the user took the prescribed, medication as prescribed but before the second prescription reminder has been presented by user device 110.

At step 714, user device 110 can cancel the second prescription reminder. For example, since user device 110 determined that the user took the prescribed medication at step 712 before the reminder was presented, user device 110 can cancel the second prescription reminder.

At step 716, user device 110 can schedule a third prescription reminder for a third time. For example, since the user took the prescribed medication at or near the second time according to the prescribed schedule, user device 110 can schedule the next prescription reminder for the next dose of the prescribed medication. For example, if the prescription specifies that the user should take the prescribed medication every eight (8) hours, then user device 110 can schedule the third prescription reminder for 8 hours after the second prescription reminder was scheduled to he presented.

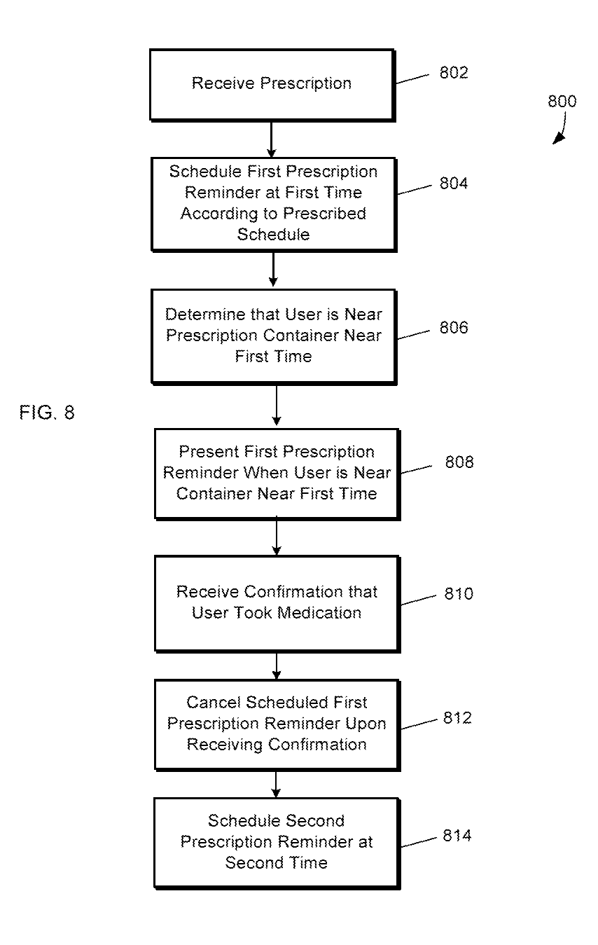

FIG. 8 is a flow diagram of an example process 800 for presenting a prescription reminder based on proximity to a prescription container device. For example, process 800 can help the user adhere to a medication schedule by reminding the user to take the prescribed medication when most convenient (e.g., when the user is near the prescription container).

At step 802, user device 110 can receive a prescription. For example, user device 110 can receive a prescription from container device 120, as described above. The prescription can be received when user device 110 is near container device 120, for example. The prescription can be transmitted from container device 120 to user device 110 using NFC, Bluetooth, Bluetooth LE, Wi-Fi and/or other communication technologies. For example, the prescription can identify a prescribed medication, specify a medication dosage amount, and describe a prescribed schedule for taking the prescribed medication.

At step 804, user device 110 can schedule a first prescription reminder at a first time according to a prescription schedule. For example, user device 110 can schedule the first prescription reminder according to the schedule described in the prescription. The user device can schedule the first prescription reminder based on when the prescription was received. For example, user device 110 can prompt the user to take the first dose of the prescribed medication when the prescription was received. User device 110 can receive an indication that the user took the first dose of the medication) and schedule the first reminder for the second dose of the prescribed medication at a first time (e.g., 8 am, 10 pm, etc.) according to the prescribed schedule.

At step 806, user device 110 can determine that the user is near the prescription container near the first time. For example, user device 110 can determine that user device 110 is near (e.g., proximate to) prescription container 120 according to the mechanisms described above. When user device 110 determines that user device 110 is near prescription container 120 at the current time, user device 110 can determine whether the current time is near the first time for presenting the scheduled prescription reminder. For example, user device 110 can determine, that the current time near the first time when the current time is within a period of time (e.g., 5 minutes, 10 minutes, etc.) before the first time for presenting the scheduled prescription reminder.

At step 808, user device 110 can present the first prescription reminder at a first when the user is near prescription container 120 near the first time for presenting the prescription reminder. For example, user device 110 can present the notification. illustrated in FIG. 4 when user device 110 determines that user device 110 is close by prescription container 120 at about the time when the user is scheduled to take the prescribed medication.

At step 810, user device 110 can receive confirmation that the user took the prescribed medication. For example, user device 110 can receive confirmation that the user took the prescribed medication according to the mechanisms described above. For example, the user can confirm that the user took the prescribed medication by selecting graphical element 406 of FIG. 4.

At step 812, user device 110 can cancel the first prescription reminder. For example, since user device 110 received confirmation that the user took the prescribed medication at step 810, user device 110 can cancel the first prescription reminder.

At step 814, user device 110 can schedule a second prescription reminder for a second time. For example, since the user took the prescribed medication at or near the first time according to the prescribed schedule, user device 110 can schedule the next prescription reminder for the next dose of the prescribed medication. For example, if the prescription. specifies that the user should take the prescribed medication every eight (8) hours, then user device 110 can schedule the second prescription reminder for 8 hours after the first prescription reminder was scheduled to be presented.

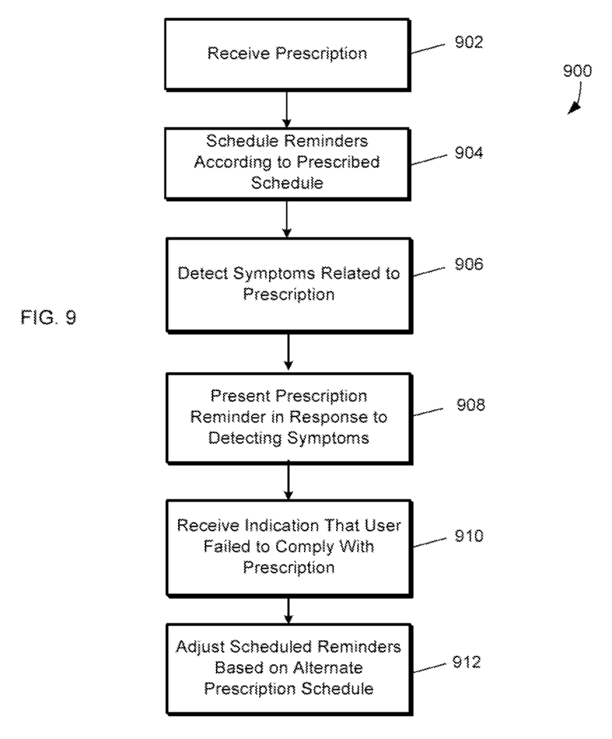

FIG. 9 is a flow diagram of an example process 900 for presenting a prescription reminder based on a user's symptoms. For example, process 900 can help the user adhere to a medication schedule by reminding the user to take the prescribed medication when the user is exhibiting symptoms associated with a condition to be treated with the prescribed medication.

At step 902, user device 110 can receive a prescription. For example, user device 110 can receive a prescription from container device 120, as described above. The prescription can he received when user device 110 is near container device 120, for example. The prescription can be transmitted from container device 120 to user device 110 using NFC, Bluetooth, Bluetooth LE, Wi-Fi and/or other communication technologies. For example, the prescription can identify a prescribed medication, specify a medication dosage amount, and describe a prescribed schedule for taking the prescribed medication.

At step 904, user device 110 can schedule prescription reminders according to a prescription schedule specified by the received prescription. For example, user device 110 can schedule the first prescription reminder according to the schedule described in the prescription. The user device can schedule the first prescription reminder based on when the prescription was received. For example, user device 110 can prompt the user to take the first dose of the prescribed medication when the prescription was received. User device 110 can receive an indication that the user took the first dose of the medication and schedule the first reminder for the second dose of the prescribed medication at a first time (e.g., 8 am, 10 pm, etc.) according to the prescribed schedule.

At step 906, user device 110 can detect symptoms related to the prescription. For example, user device 110 can detect symptoms using various sensors of user device 110, as described above. User device 110 can compare the detected symptoms to symptoms listed in the received, prescription to determine if the detected symptoms are related to (e.g., match, correspond to) the symptoms described in the prescription.

At step 908, user device 110 can present a prescription reminder in response to detecting the symptoms. For example, when user device 110 determines that the detected symptoms are related to the prescription, user device can present prescription reminder 502 of FIG. 5.

At step 910, user device 110 can receive an indication that the user failed to comply with the prescription. For example, the user can provide input to prescription reminder 502 of FIG. 5 indicating that the user missed a schedule dose of the prescribed medication.

At step 912, user device 110 can adjust the scheduled reminders based on an alternate prescription schedule described in the prescription received at step 902. For example, the prescription can include instructions from the user's doctor for how to adjust the prescription schedule when the user misses a scheduled dose or takes the wrong dosage amount. User device 110 can automatically adjust the prescribed schedule according to the doctor's instructions (e.g., the alternate schedule).

### Example System Architecture

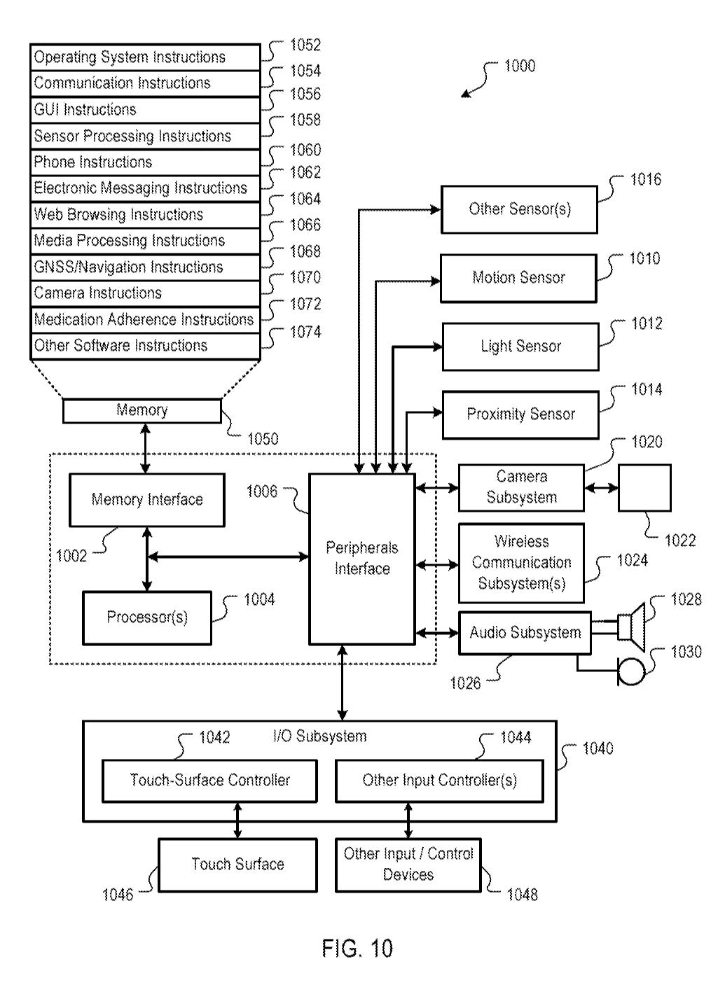

FIG. 10 is a block diagram of an example computing device 1000 that can implement the features and processes of FIGS. 1-9. The computing device 1000 can include a memory interface 1002, one or more data processors, image processors and/or central processing units 1004, and a peripherals interface 1006. The memory interface 1002, the one or more processors 1004 and/or the peripherals interface 1006 can be separate components or can be integrated in one or more integrated circuits. The various components in the computing device 1000 can be coupled by one or more communication buses or signal lines.

Sensors, devices, and subsystems can he coupled to the peripherals interface 1006 to facilitate multiple functionalities. For example, a motion sensor 1010, a light sensor 1012, and a proximity sensor 1014 can be coupled to the peripherals interface 1006 to facilitate orientation, lighting, and proximity functions. Other sensors 1016 can also be connected to the peripherals interface 1006, such as a global navigation satellite system (GNSS) (e.g., GPS receiver), a temperature sensor, a biometric sensor, magnetometer or other sensing device, to facilitate related functionalities.

A camera subsystem 1020 and an optical sensor 1022, e.g., a charged coupled device (CCD) or a complementary metal-oxide semiconductor (CMOS) optical sensor, can be utilized to facilitate camera functions, such as recording photographs and video clips. The camera subsystem 1020 and the optical sensor 1022 can be used to collect images of a user to be used during authentication of a user, e.g., by performing facial recognition analysis.

Communication functions can be facilitated through one or more wireless communication subsystems 1024, which can include radio frequency receivers and transmitters and/or optical (e.g., infrared) receivers and transmitters. The specific design and implementation of the communication subsystem 1024 can depend on the communication network(s) over which the computing device 1000 is intended to operate. For example, the computing device 1000 can include communication subsystems 1024 designed to operate over a GSM network, a GPRS network, an EDGE network, a Wi-Fi or WiMax network, and a Bluetooth™ network. In particular, the wireless communication subsystems 1024 can include hosting protocols such that the device 100 can be configured as a base station for other wireless devices.

An audio subsystem 1026 can be coupled to a speaker 1028 and a microphone 1030 to facilitate voice-enabled functions, such as speaker recognition, voice replication, digital recording, and telephony functions. The audio subsystem 1026 can be configured to facilitate processing voice commands, voice printing and voice authentication, for example.

The I/O subsystem 1040 can include a touch-surface controller 1042 and/or other input controller(s) 1044. The touch-surface controller 1042 can be coupled to a touch surface 1046. The touch surface 1046 and touch-surface controller 1042 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 1046.

The other input controller(s) 1044 can be coupled to other input/control devices 1048, such as one or more buttons, rocker switches, thumb-wheel, infrared port, USB port, and/or a pointer device such as a stylus. The one or more buttons (not shown) can include an up/down button for volume control of the speaker 1028 and/or the microphone 1030.

In one implementation, a pressing of the button for a first duration can disengage a lock of the touch surface 1046; and a pressing of the button for a second duration that is longer than the first duration can turn power to the computing device 1000 on or off. Pressing the button for a third duration can activate a voice control, or voice command, module that enables the user to speak commands into the microphone 1030 to cause the device to execute the spoken command. The user can customize a functionality of one or more of the buttons. The touch surface 1046 can, for example, also be used to implement virtual or soft buttons and/or a keyboard.

In some implementations, the computing device 1000 can present recorded audio and/or video files, such as MP3, AAC, and MPEG files. In some implementations, the computing device 1000 can include the functionality of an MP3 player, such as an iPod™. The computing device 1000 can, therefore, include a 36-pin connector that is compatible with the iPod. Other input/output and control devices can also be used.

The memory interface 1002 can be coupled to memory 1050. The memory 1050 can include high-speed random access memory and/or non-volatile memory, such as one or more magnetic disk storage devices, one or more optical storage devices, and/or flash memory (e.g., NAND, NOR). The memory 1050 can store an operating system 1052, such as Darwin, RTXC, LINUX, UNIX, OS X, WINDOWS, or an embedded operating system such as VxWorks

The operating system 1052 can include instructions for handling basic system services and for performing hardware dependent tasks. In some implementations, the operating system 1052 can be a kernel (e.g., UNIX kernel). For example, operating system 1052 can implement the medication adherence features as described with reference to FIGS. 1-9.

The memory 1050 can also store communication instructions 1054 to facilitate communicating with one or more additional devices, one or more computers and/or one or more servers. The memory 1050 can include graphical user interface instructions 1056 to facilitate graphic user interface processing; sensor processing instructions 1058 to facilitate sensor-related processing and functions; phone instructions 1060 to facilitate phone-related processes and functions; electronic messaging instructions 1062 to facilitate electronic-messaging related processes and functions; web browsing instructions 1064 to facilitate web browsing-related processes and functions; media processing instructions 1066 to facilitate media processing-related processes and functions; GNSS/Navigation instructions 1068 to facilitate GNSS and navigation-related processes and instructions; and/or camera instructions 1070 to facilitate camera-related processes and functions.

The memory 1050 can store other software instructions 1072 to facilitate other processes and functions, such as the medication adherence processes and functions as described with reference to FIGS. 1-9.

The memory 1050 can also store other software instructions 1074, such as web video instructions to facilitate web video-related processes and functions; and/or web shopping instructions to facilitate web shopping-related processes and functions. In some implementations, the media processing instructions 1066 are divided into audio processing instructions and video processing instructions to facilitate audio processing-related, processes and functions and video processing-related, processes and functions, respectively.

Each of the above identified instructions and applications can correspond to a set of instructions for performing one or more functions described above. These instructions need not be implemented as separate software programs, procedures, or modules. The memory 1050 can include additional instructions or fewer instructions. Furthermore, various functions of the computing device 1000 can be implemented in hardware and/or in software, including in one or more signal processing and/or application specific integrated circuits.

What is claimed is:

1. A method comprising:
receiving, by a mobile device from a medication storage device, a first prescription communication describing a first medication and a first medication schedule for a user;
initiating a prescription reminder schedule, by the mobile device, for a first presentation of a first prescription reminder on the mobile device at a first time according to the first medication schedule;
before presenting the first prescription reminder, receiving, by the mobile device from at least the medication storage device, a second prescription communication indicating that the first medication described in the first prescription communication was taken by the user; and
in response to receiving the indication from the medication storage device, canceling, by the mobile device, the scheduled first presentation of the first prescription reminder.

2. The method of claim 1, wherein the second prescription communication indicates a second time when the first medication was taken by the user, and further comprising:
determining, by the mobile device, that the second time is within a threshold period of time of the first time; and
based on the determination, canceling, by the mobile device, the scheduled first presentation of the first prescription reminder.

3. The method of claim 1, wherein the second prescription communication indicates a second time when the first medication was taken by the user, and further comprising:
determining, by the mobile device, that the second time does not conform to the first medication schedule; and
based on the determination, adjusting, by the mobile device, the schedule for the first presentation of the first prescription reminder so that the first prescription reminder is presented at a third time that is different than the first time.

4. The method of claim 1, wherein the prescription identifies a second medication that is known to interact with the first medication, and further comprising:
determining that the mobile device is storing a second prescription for the user that describes a prescription schedule for taking the second medication; and
in response to the determination, presenting, by the mobile device, a warning indicating that the first medication is known to interact with the second medication.

5. The method of claim 1, further comprising:
receiving, by the mobile device, a signal from the medication storage device at a fourth time;
based on the received signal, determining that the mobile device is near the medication storage device;
determining, by the mobile device, that the fourth time is within a threshold amount of time of the first time; and
in response to determining that the mobile device is near the medication storage device at a fourth time that is within a threshold amount of time of the first time, presenting, by the mobile device, an alert reminding the user to take the first medication.

6. The method of claim 1, wherein the prescription reminder is presented on a display of a wearable device.

7. The method of claim wherein the prescription reminder is presented as a haptic output.

8. A non-transitory computer-readable medium including one or more sequences of instructions that, when executed by one or more processors, cause:
receiving, by a mobile device from a medication storage device, a first prescription communication describing a first medication and a first medication schedule for a user;
initiating a prescription reminder schedule, by the mobile device, for a first presentation of a first prescription, reminder on the mobile device at a first time according to the first medication schedule;
before presenting the first prescription reminder, receiving, by the mobile device from at least the medication storage device, a second prescription communication indicating that the first medication described in the first prescription communication was taken by the user; and
in response to receiving the indication from the medication storage device, canceling, by the mobile device, the scheduled first presentation of the first prescription reminder.

9. The non-transitory computer-readable medium of claim 8, wherein the second prescription communication indicates a second time when the first medication was taken by the user, and wherein the instructions cause:
determining, by the mobile device, that the second time is within a threshold period of time of the first time; and
based on the determination, canceling, by the mobile device, the scheduled first presentation of the first prescription reminder.

10. The non-transitory computer-readable medium of claim 8, wherein the second prescription communication indicates a second time when the first medication was taken by the user, and wherein the instructions cause:
determining, by the mobile device, that the second time does not conform to the first medication schedule; and
based on the determination, adjusting, by the mobile device, the schedule for the first presentation of the first prescription reminder so that the first prescription reminder is presented at a third time that is different than the first time.

11. The non-transitory computer-readable medium of claim 8, wherein the prescription identifies a second medication that is known to interact with the first medication, and wherein, the instructions cause:
determining that the mobile device is storing a second prescription for the user that describes a prescription schedule for taking the second medication; and
in response to the determination, presenting, by the mobile device, a warning indicating that the first medication is known to interact with the second medication.

12. The non-transitory computer-readable medium of claim 8, wherein the instructions cause:
receiving, by the mobile device, a signal from the medication storage device at a fourth time;
based on the received signal, determining that the mobile device is near the medication storage device;
determining, by the mobile device, that the fourth time is within a threshold amount of time of the first time; and
in response to determining that the mobile device is near the medication storage device at a fourth time that is within a threshold amount of time of the first time, presenting, by the mobile device, an alert reminding the user to take the first medication.

13. The non-transitory computer-readable medium of claim 8, wherein the prescription reminder is presented on a display of a wearable device.

14. The non-transitory computer-readable medium of claim 8, wherein the prescription reminder is presented as a haptic output.

15. A mobile device comprising:
one or more processors: and
a non-transitory computer-readable medium including one or more sequences of instructions that, when executed by one or more processors, cause:
receiving, from a medication storage device, a first prescription communication describing a first medication and a first medication schedule for a user of the mobile device;
initiating a prescription reminder schedule, by the mobile device, for a first presentation of a first prescription reminder on the mobile device at a first time according to the first medication schedule;
before presenting the first prescription reminder, receiving, by the mobile device from at least the medication storage device, a second prescription communication indicating that the first medication described in the first prescription communication was taken by the user; and
in response to receiving the indication from the medication storage device, canceling, by the mobile device, the scheduled first presentation of the first prescription reminder.

16. The mobile device of claim 15, wherein the second prescription communication indicates a second time when the first medication was taken by the user, and wherein the instructions cause:
determining, by the mobile device, that the second time is within a threshold period of time of the first time; and
based on the determination, canceling, by the mobile device, the scheduled first presentation of the first prescription reminder.

17. The mobile device of claim 15, wherein the second prescription communication indicates a second time when the first medication was taken by the user, and wherein the instructions cause:
determining, by the mobile device, that the second time does not conform to the first medication schedule; and
based on the determination, adjusting, by the mobile device, the schedule for the first presentation of the first prescription reminder so that the first prescription reminder is presented at a thud time that is different than the first time.

18. The mobile device of claim 15, wherein the prescription identifies a second medication that is known to interact with the first medication, and wherein the instructions cause:
determining that the mobile device is storing a second prescription for the user that describes a prescription schedule for taking the second medication; and
in response to the determination, presenting, by the mobile device, a warning indicating that the first medication is known to interact with the second medication.

19. The mobile device of claim 15, wherein the instructions cause:
receiving, by the mobile device, a signal from the medication storage device at a fourth time;
based on the received signal, determining that the mobile device is near the medication storage device;
determining, by the mobile device, that the fourth time is within a threshold amount of time of the first time; and
in response to determining that the mobile device is near the medication storage device at a fourth time that is within a threshold amount of time of the first time, presenting, by the mobile device, an alert reminding the user to take the first medication.

20. The mobile device of claim 15, wherein the prescription reminder is presented on a display of a wearable device.

21. The mobile device of claim 15, wherein the prescription reminder is presented as a haptic output.
